(19) United States
(12) Patent Application Publication
(10) Pub. No.: US 2016/0162961 A1
(43) Pub. Date: Jun. 9, 2016

(54) SYSTEM AND METHOD FOR OWNERSHIP AND TRANSFER OF DIGITAL ART

(71) Applicant: Claydo Lab Ltd., Tel-Aviv (IL)

(72) Inventors: Oren Moshe, Tel-Aviv (IL); Oren J. Maurice, Moshava Yokneam (IL); Robert Anders, Tel-Aviv (IL); Xuf Mils, Jaffa (IL); Shai Snir, Tel-Aviv (IL)

(21) Appl. No.: 14/957,669

(22) Filed: Dec. 3, 2015

Related U.S. Application Data
(60) Provisional application No. 62/086,743, filed on Dec. 3, 2014.

(51) Int. Cl. G06Q 30/06; G06Q 50/18

(52) U.S. Cl. CPC G06Q 30/0607; G06Q 50/184

(57) ABSTRACT

A method of verifying, controlling and limiting distribution of digital artwork files, comprises designating a trusted third party registration server; receiving a digital artwork; registering the received artwork at the registration server; defining an allowed number of copies of the registered artwork, the allowed number being at least one; creating individual copies of the artwork up to the allowed number; at the registration server assigning an individual copy to a user; supplying the user with a file comprising an electronically watermarked version of the individual copy; allowing the user to relinquish the individual copy; upon relinquishing, making the individual copy available to a second user by repeating the supplying stage.

### RELATED APPLICATION

This application claims the benefit of priority under 35 USC 119(e) of U.S. Provisional Patent Application No. 62/086,743 filed on Dec. 3, 2014, the contents of which are incorporated herein by reference in their entirety.

### FIELD AND BACKGROUND OF THE INVENTION

The present invention, in some embodiments thereof, relates to a system and method for ownership and transfer of digital art.

Books, music and the like can be purchased in shops or in the digital world and the online and physical versions of the works operate and have value in much the same way. Works of fine art differ from other forms of content in that their value relates to their rarity. An original painting by a well-known artist is very valuable, as is a limited edition print of such a work. And in the online world it is possible to create unique artistic works in ways which are not possible in the physical world. Thus the digital art may include movement, may be a video or the like or may be designed for display on multiple screens. Sometimes there may be different versions, such as a trailer version and the full artwork version.

A need thus exists, for artists and collectors, to trade in digital art, mimicking as much as possible the trade of traditional art. However, as digital art can be copied with perfect accuracy, in ways that do not allow even the best trained individual with the best tools to discern the original and the copy, the issue of proof of ownership has to be resolved. The same is true for the verification of the number of registered copies of an artwork, making sure no copies are lost. Furthermore, it is necessary to ensure that new copies are not suddenly generated, thus destroying value of existing limited edition copies.

### SUMMARY OF THE INVENTION

The present embodiments use a trusted registrar of art ownership, or several such registrars, and may use a generalized description of a file format that is internally signed in a way that guarantees its authenticity.

According to an aspect of some embodiments of the present invention there is provided a method of verifying, controlling and limiting distribution of digital artwork files, the method comprising:

designating a registration server;

receiving a digital artwork;

registering said received artwork at said registration server;

defining an allowed number of copies of said registered artwork, said allowed number being at least one;

creating individual copies of said artwork up to said allowed number;

at said registration server assigning an individual copy to a user;

supplying said user with a file comprising an electronically watermarked version of said individual copy;

allowing said user to relinquish said individual copy;

upon relinquishing, making said individual copy available to a second user by said supplying.

The method may comprise keeping at least one copy of said digital artwork, on said registration servers.

In an embodiment, said at least one copy is in an original format.

In an embodiment, said at least one copy is a conversion to a format selected for one member of the group comprising playback and preservation.

In an embodiment, said creating individual copies comprises creating an ownership log for each respective individual copy.

In an embodiment, each individual copy is respectively provided with an electronic signature.

In an embodiment, said electronic signature requires mutual identification between said user and said registration server to open said copy.

In an embodiment, each individual copy is electronically encrypted and requires mutual identification between said user and said registration server to open said copy.

In an embodiment, each individual copy is electronically encrypted using one member of the group consisting of a symmetric key cryptosystem and a public key cryptosystem.

An embodiment may comprise providing said ownership log with a copy number of said copy and updating said ownership log with successive transactions involving said copy.

An embodiment may involve embedding within the copy a hidden transaction stamp, said hidden transaction stamp specifying which user has downloaded the artwork, and when.

In an embodiment, said hidden transaction stamp is included within said watermark.

An embodiment may comprise a visual search tool to verify whether a newly submitted artwork is or is not already registered.

An embodiment may involve providing a plurality of registration servers and an interworking protocol to allow said visual search tool to work across said plurality of registration servers.

In an embodiment, said interworking protocol further comprises copy transfer for transferring individual copies of said artwork between said registration servers for assignment to users.

An embodiment may comprise a protocol for deregistering said artwork, said protocol comprising determining an ownership of each one of said allowed number of copies, and upon receiving an approval of an owner of each copy, deregistering said artwork.

An embodiment may involve checking said artwork upon receipt for an existing registration thereof and terminating a registration process upon finding such an existing registration.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

Implementation of the method and/or system of embodiments of the invention can involve performing or completing selected tasks manually, automatically, or a combination thereof. Moreover, according to actual instrumentation and equipment of embodiments of the method and/or system of the invention, several selected tasks could be implemented by hardware, by software or by firmware or by a combination to thereof using an operating system.

For example, hardware for performing selected tasks according to embodiments of the invention could be implemented as a chip or a circuit. As software, selected tasks according to embodiments of the invention could be implemented as a plurality of software instructions being executed by a computer using any suitable operating system. In an exemplary embodiment of the invention, one or more tasks according to exemplary embodiments of method and/or system as described herein are performed by a data processor, such as a computing platform for executing a plurality of instructions. Optionally, the data processor includes a volatile memory for storing instructions and/or data and/or a non-volatile storage, for example, a magnetic hard-disk and/or removable media, for storing instructions and/or data. Optionally, a network connection is provided as well. A display and/or a user input device such as a keyboard or mouse are optionally provided as well.

### BRIEF DESCRIPTION OF THE SEVERAL VIEWS OF THE DRAWINGS

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

In the drawings:

FIG. 1 is a simplified flow chart illustrating a procedure for managing digital art according to a first embodiment of the present invention;

FIG. 2 is a simplified flow diagram illustrating a simplified acceptance procedure for a new artwork at a registrar;

FIG. 3 is a simplified flow diagram showing how an acceptance procedure for a new artwork may include checking for a watermark, carrying out a visual search and using human dispute resolution, according to an embodiment of the present invention;

FIG. 4 is a simplified flow chart illustrating a procedure for downloading a file to an end user; and

FIG. 5 is a simplified flow chart illustrating a procedure for de-registering an artwork.

### DESCRIPTION OF SPECIFIC EMBODIMENTS OF THE INVENTION

The present invention, in some embodiments thereof, relates to a system and method for ownership of digital art.

The present embodiments use one or more designated registration servers or registrars which store the digital artworks and manage and restrict their distribution. The distribution of digital artworks differs from other kinds of digital distribution in the following ways. Digital distribution of copyright media in general is controlled but only in the sense that everyone who obtains a copy pays for that copy. Aside from the payment issue, there is no limit to the number of copies in circulation. On the other hand, distribution of confidential business information and the like is controlled so that only the intended people receive the information and not others. Again there is no concern regarding the total number of copies in circulation. Rather the issue is who gets to see the work.

With digital artwork, the value of the work depends on its rarity. There is no limitation as to who may see the work or what class of people may see the work, and the concern is not that anyone who pays should get to see the work. Rather the concern is that there are only a given number of copies of the work in circulation. That is to say the rarity value is the factor to be preserved.

Furthermore the value of an artwork depends on an aftermarket. A work of art becomes valuable because it can be sold. Thus the present embodiments seek to provide a system and method that guarantees only a limited number of copies and furthermore allow the individual copies to be purchased and sold while retaining their identities as digital equivalents of valuable art objects.

Before explaining at least one embodiment of the invention in detail, it is to be understood that the invention is not necessarily limited in its application to the details of construction and the arrangement of the components and/or methods set forth in the following description and/or illustrated in the drawings and/or the Examples. The invention is capable of other embodiments or of being practiced or carried out in various ways.

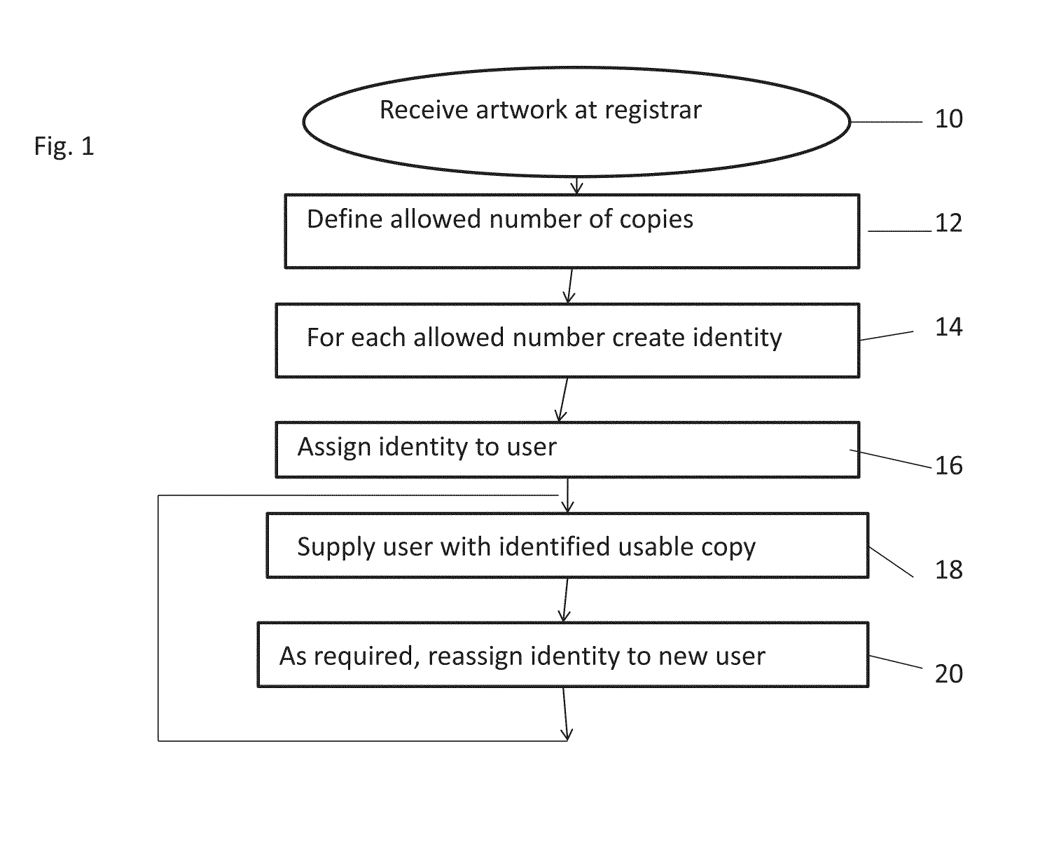

Referring now to the drawings, FIG. 1 illustrates a method of verifying, controlling and limiting distribution of digital artwork files. In the method a digital artwork is received 10 at a registrar, which is typically a server or group of dedicated servers operated by a trusted third party entity. As will be discussed below the rights of the uploader to the digital artwork may be checked at this point, but assuming that the uploader does have the rights then an allowed number of copies is defined—box 12. The allowed number may be just one, for maximum rarity value or any larger number as desired. The number of operational digital copies in circulation may not exceed the selected number. Furthermore, as users may be purchasing copies based on an understanding of the rarity, the selected number may not be changed once the first sale has been made.

Individual copies of the artwork may then be created 14 up to the allowed number. Typically at this stage the individual copies are created in the sense of a number of identities. There is no need to create separate files until downloading is requested by an end user.

Later on, the registration server may assign 16 an individual copy to a user by associating the user with the particular identity. This may happen for example when the individual user purchases or hires the copy.

The user is supplied 18 with an identified usable copy, typically a file comprising an electronically watermarked version of the identified individual copy.

The user is free at any time to relinquish the individual copy. The platform allows the user to sell, gift, lend or hire his/her copy to another user, and the new user is assigned the identity of the individual copy and provided with a usable file in the same way. As will be discussed below, the file of the original user may then be disabled.

Typically a copy of the digital artwork is retained on the registration servers, from which the files sent to the users are prepared. The retained copy may be in an original format. The copy may be a conversion to a format for better playback or preservation, or both the original and converted format may be retained.

The identities of the allowed copies for distribution may involve the creation of a transaction log or ownership log for each respective individual copy.

The individual copies may be respectively provided with an electronic signature. The signature may verify to the user that the file is the genuine file from the registrar and may additionally verify to the registrar that the file is being opened by the legitimate end user. That is to say, the electronic signature may require mutual identification between the user and the registration server to open the copy.

Additionally or alternatively, each individual copy is electronically encrypted and requires mutual identification between the user and the registration server to open the copy. Electronic encryption with mutual identification may for example be provided via a symmetric key cryptosystem or a public key cryptosystem.

The ownership/transaction log may include a copy number of the individual copy and the log may be updated with successive transactions involving the copy.

The method may involve embedding within the copy a hidden transaction stamp, for example as an electronic watermark. The watermark may be inserted using steganographic techniques to make it hard to find and hard to remove. The transaction stamp may specify the copy number, the registrar or other identification details and the most recent transaction events, such as which user has most recently downloaded the artwork. The stamp thus defines the end user that the file is supposed to work with.

The registrar server may include a visual search tool to verify whether a newly submitted artwork is or is not already registered. Thus if similar images to those received are found then the ownership of the artwork may be queried.

In the case that multiple registration servers are used, an interworking protocol may be provided to allow the visual search tool to work across all of the registration servers, so that ownership can be queried if any of the servers have a similar image.

The interworking protocol may include a copy transfer feature for transferring individual copies of the artwork between different registration servers for assignment to users. Individual servers may serve different geographical regions or suchlike, and the interworking protocol allows different copies to be distributed over the different servers as desired, or to be transferred to a particular server when a copy is requested by a user connected to that server. Likewise, the management of the original artwork may be transferred between servers as desired.

Upon receipt of a new artwork, the artwork may be checked for an existing registration. For example the received data may be checked for an existing watermark, as well as for visual similarity to already registered works. The registration process may be terminated or reverted to some form of arbitration upon finding such an existing registration.

In more detail, the present embodiments may rely upon keeping copies of the artwork, whether in its original format, or as conversions to common formats for to playback and preservation, on the servers of a registrar or trusted independent party. Once defined, the registrar may define an ownership log for every individual copy of the artwork.

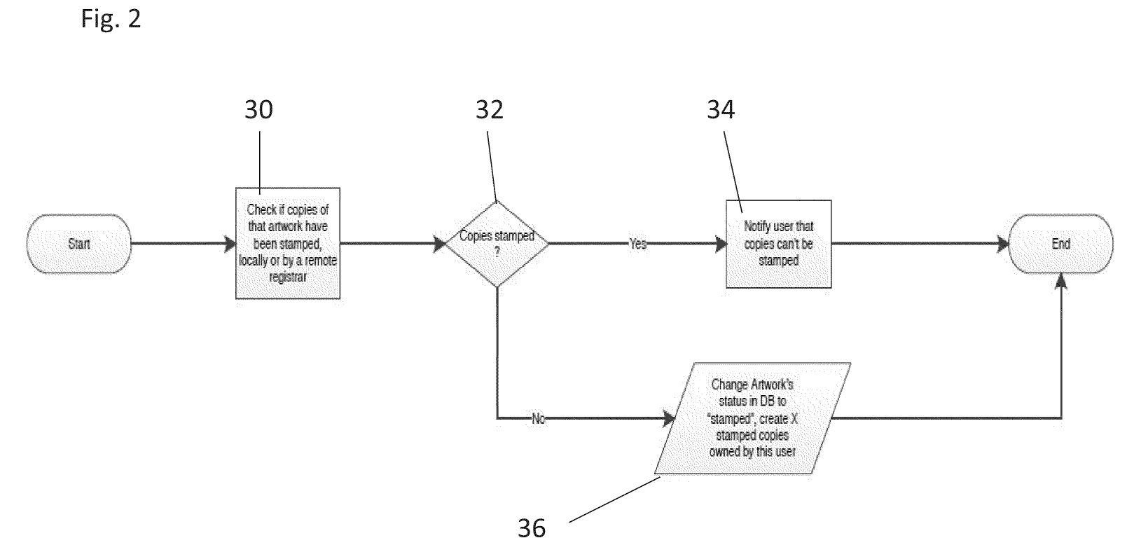

Reference is now made to FIG. 2, which is a simplified flow diagram illustrating a process for registering a new artwork arriving at the registrar. The arriving copy is checked 30 to make sure that it does not have a stamp or watermark. The result of checking is queried 32 and if the new artwork already contains a stamp then the user is notified that the work cannot be accepted and cannot be stamped 34. If on the other hand the new artwork is free of any kind of stamp or watermark then in box 36 the artwork is accepted by the system and the required number of stamped copies are created.

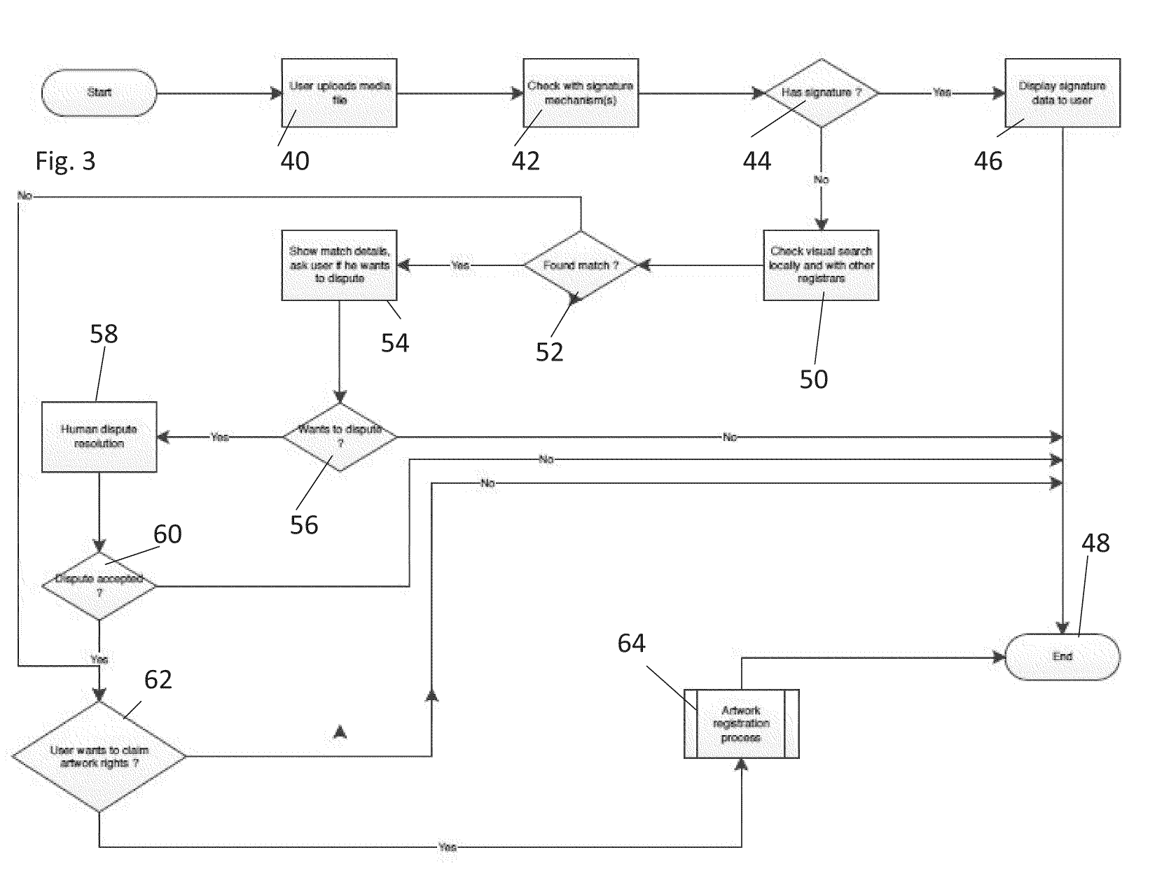

Reference is now made to FIG. 3, which is a simplified diagram showing a more detailed registration process. The registration is preceded by a legality search. An artwork file, or the artwork media, can be uploaded to a registrar, where two methods may be employed to identify the work:
1. A watermark-detection system can check if the artwork is a watermarked copy. If it is, the exact copy number can be deduced, as well as ownership, and details of the managing registrar.
2. An existing visual-search engine can be employed, and the registrar may query its own database and the databases of all other registrars for a match, to verify that the artwork isn't registered already. If already registered then the general implication would be that the currently uploaded copy is an illegal copy, but it is possible that the earlier version was the illegal copy.

In more detail, the digital art file is uploaded 40. The upload is checked 42 against the various signature mechanisms to determine whether it has any of the signatures or watermarks being used in the system. If the artwork has a signature 44 then the signature data is displayed 46 to the uploading user and the process ends 48. If the artwork does not have signature or watermark data then the artwork is submitted for a visual search 50 to compare with local and other registrar databases to see if the same or a visually similar artwork is already on the database. If a match is found 52 then the match details may be shown 54 to the uploading user. The user may be offered the option to dispute the finding. The match may not be exact or the uploading user may believe he is the legitimate owner as opposed to some previous uploader. In the event that the user wishes to dispute 56 the finding then human dispute resolution may be used 58. If the dispute is not upheld the process ends. If the dispute is upheld 60 then the uploading user may be able to claim rights to the artwork 62. If either the dispute is upheld or if no match was found in the first place then the registration process 64 may be entered and the artwork may be registered.

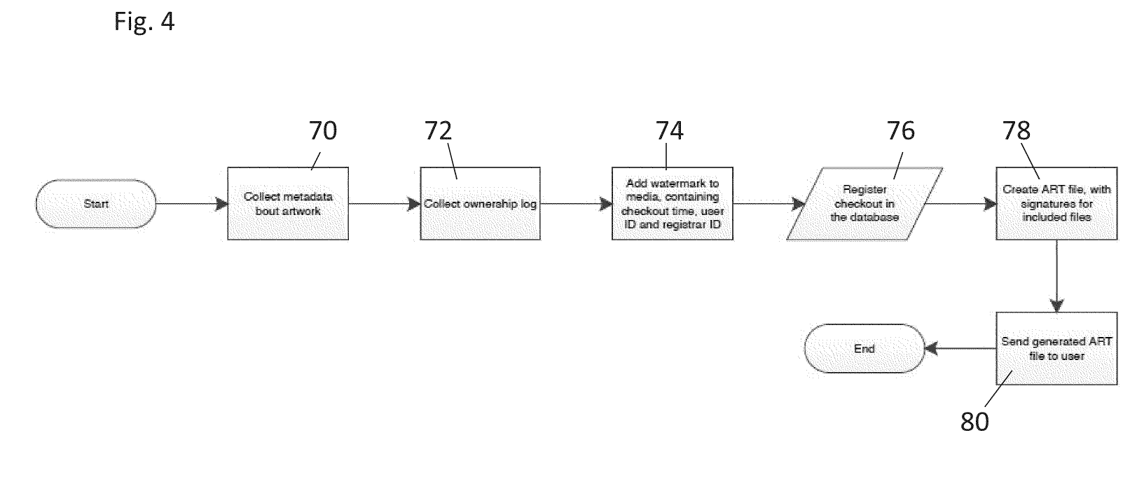

Reference is now made to FIG. 4 which is a simplified flow chart illustrating a process for issuing one of the limited number of copies of an artwork to a user. The artwork may be associated with different kinds of metadata which is collected in stage 70. The ownership log for the particular copy is also obtained in box 72. A watermark is inserted into the media, using cryptographic or steganographic techniques or both in box 74. The distribution of the copy is registered in the database—box 76 and a file is created 78, known as an ART file, which includes all the signatures, the ownership log and the media itself. The ART file may include the metadata as needed or that may be retained on the registration server as preferred. In box 80 the generated ART file is sent to the end user.

When a user owns an artwork, he may download a copy, using the ART format. The copy may be either in plaintext or encrypted, for example with a symmetric or an asymmetric cipher, for which he is given the appropriate key. The copy may include the artwork media itself, as well as the signed ownership log. The log may include all past transactions, and the number of the artwork copy in the existing copies list. The media itself may include a hidden transaction stamp which specifies which user has downloaded the artwork, and when. The stamp may be added almost invisibly to the artwork media itself, in a manner that is hard to remove, allowing the registrar to later verify if a given media item has been downloaded from a registrar, when and by whom, for example in order to fight piracy.

The ART file format may be based on the ZIP protocol, and may use the ZIP symmetric cipher. The ART file, the downloadable form of the owned artwork or copy may thus be contained in a standard ZIP file, and includes multiple files, including, but not limited to:
1. Media files belonging to the artwork (Video, Image, or programmatic content);
2. Metadata regarding the artwork (artist, creation date, style);
3. Ownership log, listing owners of the artwork, and dates of purchase and sale for each one;
4. Signature file, containing a hash of all the other files, and itself signed by a public-key cipher, guaranteeing the authenticity of the ART file's contents.

Invisible watermark: Invisible watermarks (Steganography) are a commonly known technique. Some are reasonably robust against tampering and removal, and often the techniques are based on frequency-domain alterations with multiple duplications per media item.

A registrar may incorporate the visual search tool as mentioned, thus allowing it to verify whether a newly submitted artwork is or is not registered in the system, thus avoiding duplicate registrations of the same work.

An inter-registrar protocol may allow every copy of an artwork to be stored and traded on any registrar, transferring the artwork's copy from one to another as desired.

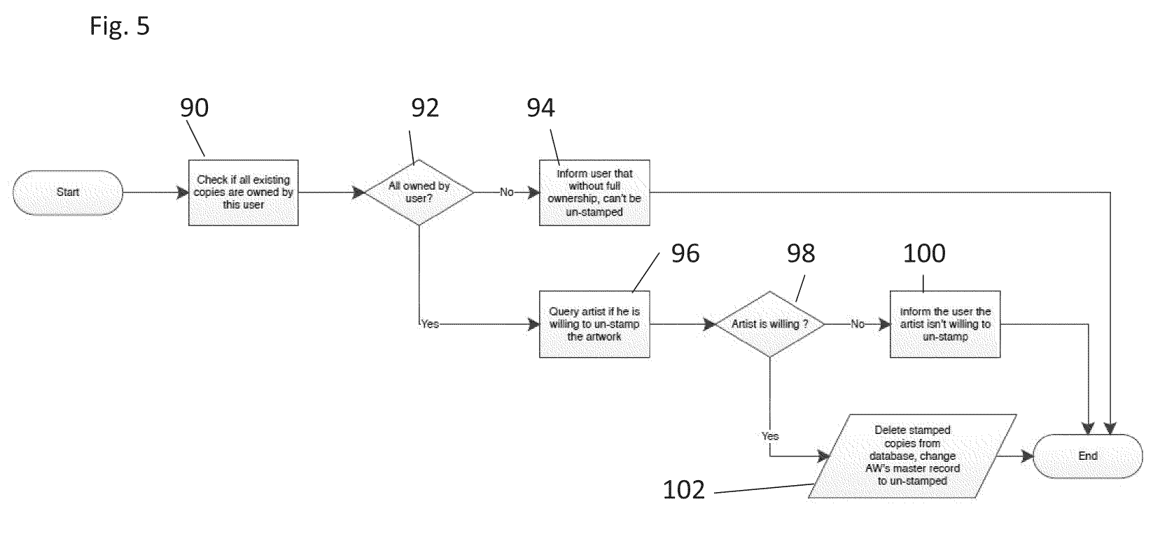

Reference is now made to FIG. 5, which is a simplified flow chart illustrating a protocol for deregistering the artwork. Clearly if users own copies whose value depends on rarity then other users cannot be allowed to do what they like with their copies and undermine the paid-for value to the remaining users. The protocol for deregistering may thus involve determining an ownership of each one of the allowed copies of the artwork, and only upon receiving an approval of the owner of each copy, deregistering the artwork. More particularly, in box 90 the user requesting deregistration, or unstamping, is checked to see if he owns all the circulating copies of the work. If they are not all owned by the user—box 92—then flow proceeds to box 94 where the user is informed that without full ownership it is not possible to deregister the work. If the owner is the owner of all copies then progress proceeds to box 96 and the artist is queried as to whether he/she is happy to unstamp the work. The need for the artist's approval may depend on the exact contract used and may thus be dispensed with in some cases. If the artist is not willing then flow proceeds to box 100 and the user is told that unstamping cannot take place. If the artist is willing then in box 102 the stamps are deleted from the copies which can now be freely used. The status of the work is changed to unstamped.

It is expected that during the life of a patent maturing from this application many relevant file formats, electronic signatures and forms of encryption and steganography will be developed and the scope of the corresponding terms is intended to include all such new technologies a priori.

The terms “comprises”, “comprising”, “includes”, “including”, “having” and their conjugates mean “including but not limited to”.

The term “consisting of” means “including and limited to”.

As used herein, the singular form “a”, “an” and “the” include plural references unless the context clearly dictates otherwise.

It is appreciated that certain features of the invention, which are, for clarity, described in the context of separate embodiments, may also be provided in combination in a single embodiment, and the above description is to be construed as if this combination were explicitly written. Conversely, various features of the invention, which are, for brevity, described in the context of a single embodiment, may also be provided separately or in any suitable subcombination or as suitable in any other described embodiment of the invention, and the above description is to be construed as if these separate embodiments were explicitly written. Certain features described in the context of various embodiments are not to be considered essential features of those embodiments, unless the embodiment is inoperative without those elements.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention. To the extent that section headings are used, they should not be construed as necessarily limiting.

What is claimed is:

1. A method of verifying, controlling and limiting distribution of digital artwork files, the method comprising:
designating a registration server;
receiving a digital artwork;
registering said received artwork at said registration server;
defining an allowed number of copies of said registered artwork, said allowed number being at least one;
creating individual copies of said artwork up to said allowed number;
at said registration server assigning an individual copy to a user;
supplying said user with a file comprising an electronically watermarked version of said individual copy;
allowing said user to relinquish said individual copy;
upon relinquishing, making said individual copy available to a second user by said supplying.

2. The method of claim 1, comprising keeping at least one copy of said digital artwork, on said registration servers.

3. The method of claim 2, wherein said at least one copy is in an original format.

4. The method of claim 2, wherein said at least one copy is a conversion to a format selected for one member of the group comprising playback and preservation.

5. The method of claim 1, wherein said creating individual copies comprises creating an ownership log for each respective individual copy.

6. The method of claim 1, wherein each individual copy is respectively provided with an electronic signature.

7. The method of claim 6, wherein said electronic signature requires mutual identification between said user and said registration server to open said copy.

8. The method of claim 1, wherein each individual copy is electronically encrypted and requires mutual identification between said user and said registration server to open said copy.

9. The method of claim 1, wherein each individual copy is electronically encrypted using one member of the group consisting of a symmetric key cryptosystem and a public key cryptosystem.

10. The method of claim 5, further comprising providing said ownership log with a copy number of said copy and updating said ownership log with successive transactions involving said copy.

11. The method of claim 10, further comprising embedding within the copy a hidden transaction stamp, said hidden transaction stamp specifying which user has downloaded the artwork, and when.

12. The method of claim 11, wherein said hidden transaction stamp is included within said watermark.

13. The method of claim 1, further comprising a visual search tool to verify whether a newly submitted artwork is or is not already registered.

14. The method of claim 13, comprising providing a plurality of registration servers and an interworking protocol to allow said visual search tool to work across said plurality of registration servers.

15. The method of claim 14, wherein said interworking protocol further comprises copy transfer for transferring individual copies of said artwork between said registration servers for assignment to users.

16. The method of claim 1, further comprising a protocol for deregistering said artwork, said protocol comprising determining an ownership of each one of said allowed number of copies, and upon receiving an approval of an owner of each copy, deregistering said artwork.

17. The method of claim 1, further comprising checking said artwork upon receipt for an existing registration thereof and terminating a registration process upon finding such an existing registration.
